(19) United States
(12) Patent Application Publication
(10) Pub. No.: US 2026/0332033 A1
(43) Pub. Date: Oct. 22, 2026

(54) UPPER ARM DRIVE CIRCUIT

(71) Applicant: Minebea Power Semiconductor Device Inc., Hitachi-shi, Ibaraki (JP)

(72) Inventor: Kazuki TANI, Tokyo (JP)

(21) Appl. No.: 19/484,036

(22) PCT Filed: Feb. 15, 2024
(86) PCT No.: PCT/JP2024/005170

§ 371 Date: Nov. 13, 2025

(30) Foreign Application Priority Data
May 29, 2023 (JP) 2023-087489

(51) Int. Cl. H02M 1/08; H02M 1/00; H02M 1/34; H02M 7/219

(52) U.S. Cl. CPC H02M 1/08; H02M 1/0058; H02M 1/346; H02M 7/2195

(57) ABSTRACT

An upper arm drive circuit includes a turn-off circuit connected between a reference potential of a power conversion device and a gate of an upper arm output element for turning off the gate. A turn-on circuit is connected between the main power supply and the gate for turning on the gate. A charge storage circuit includes a capacitor and a first backflow preventor. A charge control circuit includes a first switching element, a resistor, and a second backflow preventor. One terminal of the capacitor is connected to the output terminal of the power conversion device via the first backflow preventor and is connected to the gate via the second backflow preventor. The other terminal of the capacitor is connected to the reference potential via the first switching element and is connected to the output terminal of the power conversion device via the resistor.

### TECHNICAL FIELD

The present invention relates to an upper arm drive circuit of a power conversion device.

### BACKGROUND ART

Due to growing awareness of environmental conservation worldwide, demands for energy saving are further increasing, and power conversion devices are widely adopted in various fields. In a power conversion device mounted on a drive system such as a railway vehicle or an air conditioner, miniaturization, weight reduction, and high reliability are important issues as well as high performance and high efficiency.

As a background art of the power conversion device, for example, there is a technology such as PTL 1, and PTL 1 discloses that “An upper arm drive circuit that drives and controls an upper arm switching element of a power conversion device, the upper arm drive circuit of a power conversion device, the upper arm drive circuit including: a capacitor connected between a gate of the upper arm switching element and an output terminal of the power conversion device; a backflow prevention circuit that is connected between a power supply of the power conversion device and the capacitor, causes a current to flow from a first terminal side connected to the power supply side to a second terminal side connected to the capacitor side, and prevents a backflow of the current from the second terminal side to the first terminal side; and a capacitor charging switching element that is connected in series with the first terminal side or the second terminal side of the backflow prevention circuit between the power supply and the capacitor, and turns on in synchronization with a command signal for turning on the upper arm switching element” with respect to “upper arm drive circuit having bridge circuit configurated with upper and lower arms, and method for controlling the same”.

### CITATION LIST

### Patent Literature

PTL 1: JP 2022-24572 A

### SUMMARY OF INVENTION

### Technical Problem

As described above, in the power conversion device, miniaturization, weight reduction, and high reliability are important issues as well as high performance and high efficiency. According to PTL 1 described above, “A power conversion device including a bridge circuit including upper and lower arms, in which a gate voltage of an upper arm switching element can be held without using a latch circuit”. However, in the upper arm drive circuit disclosed in PTL 1, the gate of the upper arm switching element cannot be turned on in a state where the potential of the output terminal is substantially equal to the power supply potential, and for example, the upper arm switching element cannot be turned on at the time of the free wheeling operation. Therefore, there is a disadvantage that the synchronous rectification operation for reducing the loss cannot be performed.

An object of the present invention is to provide an upper arm drive circuit that can increase a gate voltage of an upper arm switching element regardless of a potential of an output terminal of a power conversion device in the power conversion device having a bridge circuit including upper and lower arms, and can improve efficiency of the power conversion device, and a control method thereof.

### Solution to Problem

An upper arm drive circuit that drives and controls an upper arm output element of a power conversion device according to an embodiment of the present invention is characterized in including: a turn-off circuit which is connected between a reference potential of a power conversion device and the gate of an upper arm output element and turns off the gate of the upper arm output element; a turn-on circuit which is connected between the main power supply of the power conversion device and the gate of the upper arm output element and turns on the gate of the upper arm output element; a charge storage circuit provided with a first capacitor and a first backflow prevention element; a charge charging/discharging control circuit provided with a first switching element and a first resistor; and a second backflow prevention element. The upper arm drive circuit is further characterized in that: one terminal of the first capacitor is connected to the output terminal of the power conversion device via the first backflow prevention element and is connected to the gate of the upper arm output element via the second backflow prevention element; and the other terminal of the first capacitor is connected to the reference potential of the power conversion device via the first switching element and is connected to the output terminal of the power conversion device via the first resistor.

### Advantageous Effects of Invention

According to the present invention, in a power conversion device having a bridge circuit including upper and lower arms, it is possible to realize an upper arm drive circuit and a control method thereof capable of increasing a gate voltage of an upper arm switching element regardless of a potential of an output terminal of a power conversion device and improving efficiency of the power conversion device.

### BRIEF DESCRIPTION OF DRAWINGS

FIG. 1 is a diagram illustrating a specific example of a conventional upper arm drive circuit.

FIG. 2 is a timing chart illustrating an operation of a conventional upper arm drive circuit.

FIG. 3 is a diagram illustrating a specific example of an upper arm drive circuit according to a first embodiment of the present invention.

FIG. 4 is a timing chart illustrating an operation of the upper arm drive circuit according to the first embodiment of the present invention.

FIG. 5 is a diagram illustrating a specific example of an upper arm drive circuit according to a second embodiment of the present invention.

FIG. 6 is a diagram illustrating a specific example of an upper arm drive circuit according to a third embodiment of the present invention.

FIG. 7 is a diagram illustrating a specific example of an upper arm drive circuit according to a fourth embodiment of the present invention.

FIG. 8 is a diagram illustrating a specific example of an upper arm drive circuit according to a fifth embodiment of the present invention.

FIG. 9 is a timing chart illustrating an operation of the upper arm drive circuit according to the fifth embodiment of the present invention.

### DESCRIPTION OF EMBODIMENTS

Hereinafter, embodiments of the present invention will be described with reference to the drawings. In the drawings, the same components are denoted by the same reference numerals, and the detailed description of overlapping components is omitted.

### First Embodiment

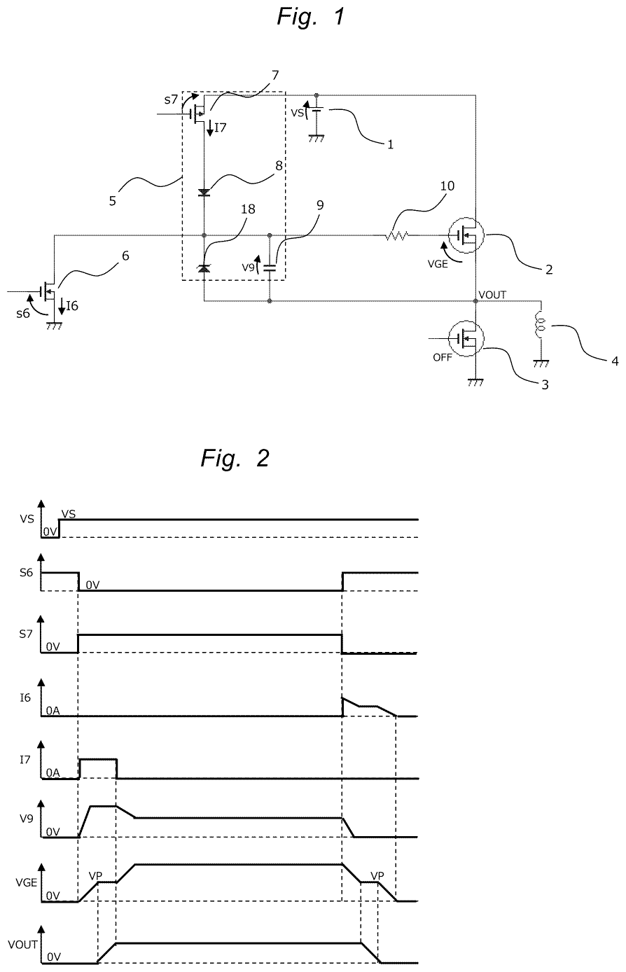

First, problems in the above-described conventional upper arm drive circuit will be described in detail with reference to FIGS. 1 and 2. FIG. 1 is a diagram illustrating a schematic configuration of an upper arm drive circuit of a conventional power conversion device, and FIG. 2 is a timing chart illustrating an operation thereof.

Note that, in the following description, an example of a half-bridge circuit including only one leg including a power MOSFET on upper and lower sides as an output element will be described, but the object of the present invention is not limited thereto, and the present invention can also be applied to a power conversion device of a three-phase full-bridge circuit configured by connecting another leg of the half-bridge circuit to form a full-bridge configuration and connecting each output terminal (U-phase, V-phase, W-phase) of three-phase AC to a neutral point of each leg. In addition, although a configuration using a power MOSFET as an output element will be described, the output element may be configured by a switching element such as an IGBT and a freewheeling diode connected in antiparallel thereto.

In FIG. 1, a switching element 2 is an upper arm output element of the power conversion device, and a switching element 3 is a lower arm output element of the power conversion device. As illustrated in FIG. 1, in the conventional power conversion device, a load (coil) 4 is connected to an output terminal VOUT, and a main power supply 1 of the power conversion device is connected to a drain terminal of the switching element 2.

In the upper arm drive circuit, a switching element 7, a backflow prevention element (diode) 8, and a gate delay circuit (resistor) 10 are connected in series between the main power supply 1 of the power conversion device and the gate of the switching element 2, a voltage limiting element (Zener diode) 18 and a capacitor 9 are connected in parallel between the gate of the switching element 2 and the output terminal VOUT of the power conversion device via the gate delay circuit (resistor) 10, and a switching element 6 is connected between the gate of the switching element 2 and the reference potential (ground) of the power conversion device via the gate delay circuit (resistor) 10.

As illustrated in FIG. 2, in the upper arm drive circuit of the conventional power conversion device, the switching element 6 is turned on in advance, the main power supply 1 is turned on, and the drain voltage of the switching element 2 rises to the power supply potential VS of the main power supply 1. Next, by turning off the switching element 6 by the upper arm ON command signal and turning on the switching element 7, a current 17 flows from the main power supply 1 via the switching element 7 and the backflow prevention element (diode) 8, and the capacitor 9 is charged.

The voltage rise of the capacitor 9 is limited to a predetermined value or less by a voltage limiting element (Zener diode) 18. Further, charges are injected into the gate of the switching element 2 via the gate delay circuit (resistor) 10 to increase the gate voltage VGE of the switching element 2. When the gate voltage VGE of the switching element 2 becomes equal to or higher than a threshold (Vth), a current starts to flow through the switching element 2.

Furthermore, when the gate voltage VGE of the switching element 2 increases to a predetermined value corresponding to the load current, the potential of the output terminal VOUT increases. During a period in which the potential of the output terminal VOUT rises, the gate voltage VGE hardly rises due to the influence of the feedback capacitance of the switching element 2. This period is referred to as a plateau period, and the gate voltage VGE in this period is referred to as a plateau voltage VP.

When the potential of the output terminal VOUT rises to the same level as the power supply potential VS of the main power supply 1, the current 17 does not flow, but the charge accumulated in the capacitor 9 continues to charge the gate of the switching element 2 via the gate delay circuit (resistor) 10 until a potential V9 between both terminals of the capacitor 9 and the gate voltage VGE of the switching element 2 become equal, and the gate voltage VGE can be sufficiently increased, so that the conduction loss of the switching element 2 can be reduced.

Subsequently, by turning off the switching element 7 and turning on the switching element 6 by the upper arm off command signal, the gate of the switching element 2 is discharged, the switching element 2 is turned off, and the potential of the output terminal VOUT decreases to the reference potential (ground).

As described above, in the upper arm drive circuit of the conventional power conversion device, after the switching element 2 is turned on and the potential of the output terminal VOUT rises, the gate of the switching element 2 is charged only with the charge accumulated in the capacitor 9, so that the plateau voltage VP at the turn-on time affects the steady gate voltage VGE at the on-time. In addition, since it is known that the plateau voltage VP changes depending on the load current and the environmental temperature, the conventional upper arm drive circuit has a disadvantage that the gate voltage VGE at the time of ON changes depending on the use condition.

In addition, as described above, since the current 17 flows only when the output terminal VOUT is lower than the power supply potential VS of the main power supply 1, in a case where the potential of the output terminal VOUT increases due to the switching of the lower arm, for example, in a case where the upper arm transitions from the off state to the free wheeling operation, even if an ON command is input to the upper arm drive circuit for synchronous rectification, the current 17 does not flow because the output terminal VOUT is already at substantially the same potential as the power supply potential VS of the main power supply 1, and there is a disadvantage that the upper arm cannot be turned on to perform the synchronous rectification operation.

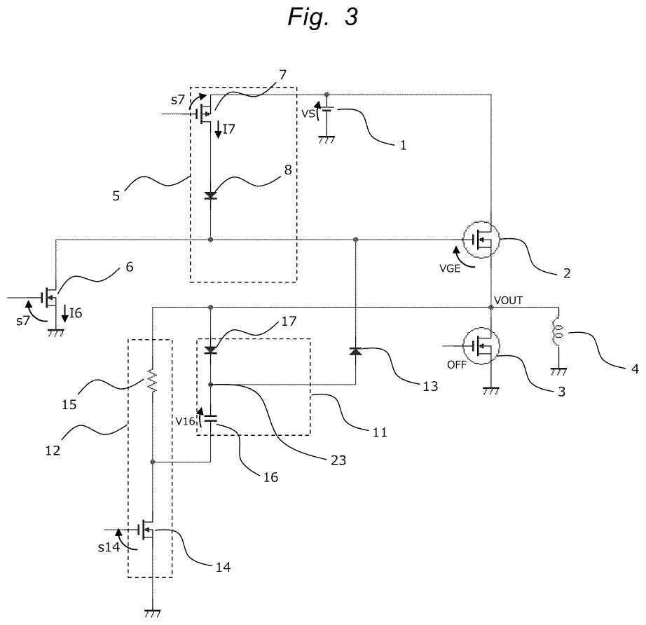

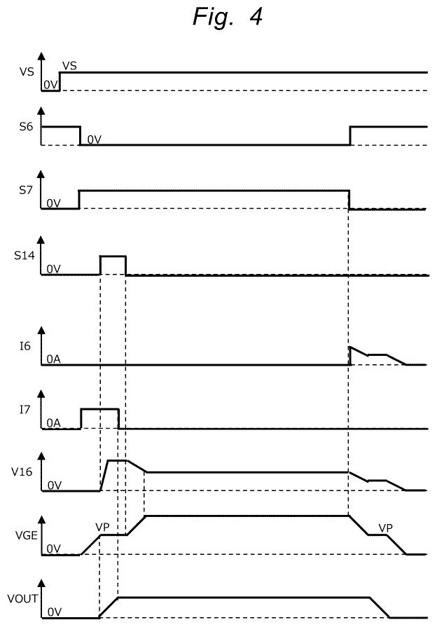

A configuration of the upper arm drive circuit according to the first embodiment of the present invention and a control method thereof will be described with reference to FIGS. 3 and 4. FIG. 3 is a diagram illustrating a schematic configuration of an upper arm drive circuit of the power conversion device according to the first embodiment of the present invention, and FIG. 4 is a timing chart illustrating an operation thereof.

The main power supply 1 of the power conversion device is connected to a drain terminal of the switching element 2 of the upper arm output element, the switching element 2 and the switching element 3 of the lower arm output element are connected at the output terminal VOUT, and the load (coil) 4 is connected to the output terminal VOUT.

In the upper arm drive circuit, a turn-on circuit 5 including a switching element 7 and a backflow prevention element (diode) 8 is connected between the main power supply 1 and the gate of the switching element 2, a switching element 6 of the turn-off circuit is connected between the gate of the switching element 2 and a reference potential (ground) of the power conversion device, a charge storage circuit 11 including a backflow prevention element (diode) 17 and a capacitor 16 is connected to the gate of the switching element 2 via the backflow prevention element (diode) 13, a charge charging/discharging control circuit 12 including a switching element 14 and a resistor 15 is connected between the output terminal VOUT and the reference potential (ground), and one end of the capacitor 16 is connected to a contact between the switching element 14 and the resistor 15.

As illustrated in FIG. 4, in the upper arm drive circuit of the power conversion device according to the first embodiment of the present invention, the switching element 6 is turned on in advance, and the main power supply 1 is turned on so that the drain voltage of the switching element 2 increases to the power supply potential VS of the main power supply 1. Next, by turning off the switching element 6 by the upper arm ON command signal and turning on the switching element 7, the current 17 flows from the main power supply 1 through the switching element 7 and the backflow prevention element (diode) 8, and charges are injected into the gate of the switching element 2 to increase the gate voltage VGE of the switching element 2.

When the gate voltage VGE of the switching element 2 becomes equal to or higher than a threshold (Vth), a current starts to flow through the switching element 2. Furthermore, when the gate voltage VGE of the switching element 2 increases to a predetermined value corresponding to the load current, the potential of the output terminal VOUT increases. During a period in which the potential of the output terminal VOUT rises, the gate voltage VGE hardly rises due to the influence of the feedback capacitance of the switching element 2. By turning on the switching element 14 during this plateau period, charges are accumulated in the capacitor 16 from the output terminal VOUT via the backflow prevention element (diode) 17.

When the potential of the output terminal VOUT increases to the same level as the power supply potential VS of the main power supply 1, the current 17 does not flow. However, when the switching element 14 is turned off, the drain potential of the switching element 14 increases to the same potential as the potential of the output terminal VOUT. Then, the potential of a contact 23 between the capacitor 16 and the backflow prevention element (diode) 17 becomes VOUT+V16 by the voltage V16 applied between both terminals of the capacitor 16, and is higher than the potential (VOUT+VGE) of the gate of the switching element 2. Therefore, the charge accumulated in the capacitor 16 is injected into the gate of the switching element 2 via the backflow prevention element (diode) 13, and the gate potential VGE rises until VGE and V16 become equal. As a result, since the gate potential VGE can be sufficiently increased, the conduction loss of the switching element 2 can be reduced.

When it is desired to further increase the gate potential VGE to reduce the conduction loss of the switching element 2, the switching element 14 may be repeatedly turned ON (charge accumulation in the capacitor 16) and OFF (charge injection into the gate of the switching element 2) a plurality of times.

Subsequently, by turning off the switching element 7 and turning on the switching element 6 by the upper arm off command signal, the charges accumulated in the gate of the switching element 2 and the capacitor 16 are discharged, the switching element 2 is turned off, and the potential of the output terminal VOUT decreases to the reference potential (ground).

According to the upper arm drive circuit and the control method thereof of the first embodiment of the present invention described above, even after the potential of the output terminal VOUT rises to the power supply potential VS of the main power supply 1 due to turn-on, the gate voltage VGE of the switching element 2 of the upper arm can be arbitrarily raised by the charge storage circuit 11 and the charge charging/discharging control circuit 12. Therefore, highly efficient control of the power conversion device becomes possible by reducing conduction loss. In FIG. 1, the switching element 7 is connected closer to the main power supply 1 side than the backflow prevention element (diode) 8, but the order of the switching element 7 and the backflow prevention element 8 may be any order.

### Second Embodiment

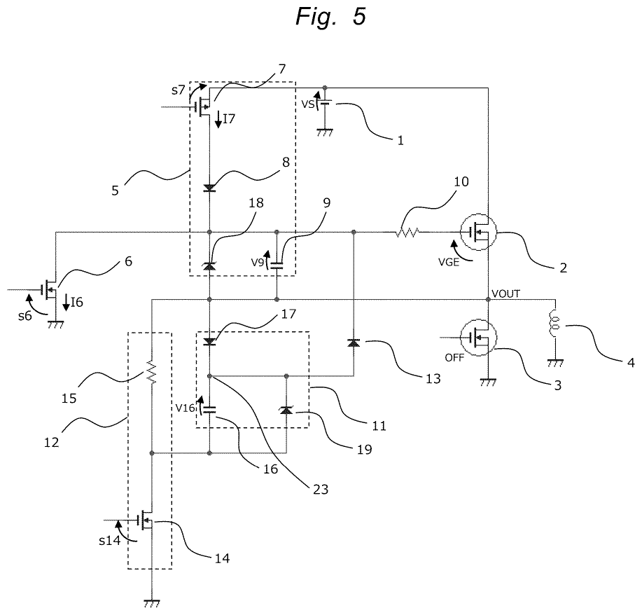

Next, a configuration of an upper arm drive circuit according to a second embodiment of the present invention will be described with reference to FIG. 5. The difference from FIG. 3 is that the voltage limiting element (Zener diode) 18 and the capacitor 9 are connected between the gate and the source (output terminal VOUT) of the switching element 2, the gate delay circuit (resistor) 10 is connected between the backflow prevention element (diode) 8 and the gate of the switching element 2, and a voltage limiting element (Zener diode) 19 is connected in parallel to the capacitor 16.

Note that there is no problem even if the voltage limiting element (Zener diode) 19 is connected in parallel to the resistor 15. In FIG. 5, the backflow prevention element (diode) 13 is connected to the gate of the switching element 2 via the gate delay circuit (resistor) 10, but there is no problem even if the backflow prevention element (diode) 13 is directly connected to the gate of the switching element 2.

In the configuration of the second embodiment of the present invention in FIG. 5, the voltage limiting element (Zener diode) 18 and the capacitor 9 prevent an instantaneous overvoltage from being applied to the gate of the switching element 2, and the gate current is limited by the gate delay circuit (resistor) 10, so that the switching speed of the switching element 2 can be appropriately controlled. In addition, the charge accumulated in the capacitor 9 can further increase the gate voltage VGE of the switching element 2 after the switching element 2 is turned on. In addition, since the voltage applied to the capacitor 16 can be precisely limited by the voltage limiting element (Zener diode) 19, the gate voltage rise of the switching element 2 by the charge charging/discharging control circuit 12 can be more precisely controlled.

### Third Embodiment

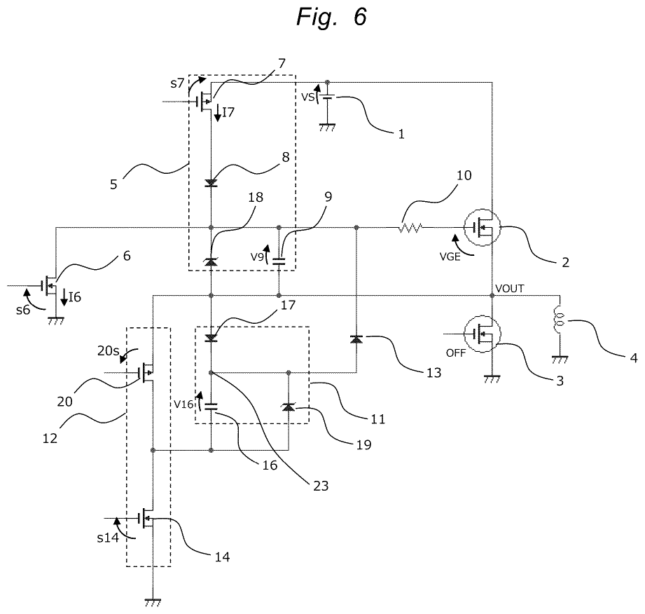

Next, a configuration of an upper arm drive circuit according to a third embodiment of the present invention will be described with reference to FIG. 6. A difference from FIG. 5 is that the resistor 15 is replaced with a switching element 20. When the switching element 14 is turned on, the switching element 20 is controlled to be turned off, and when the switching element 14 is turned off, the switching element 20 is controlled to be turned on.

By using the switching element 20, power consumption can be reduced in a period in which the switching element 14 is on (a period in which charges are accumulated in the capacitor 16) as compared with a case where the resistor 15 is used, and the switching speed can be improved when the switching element 14 is switched from on to off.

### Fourth Embodiment

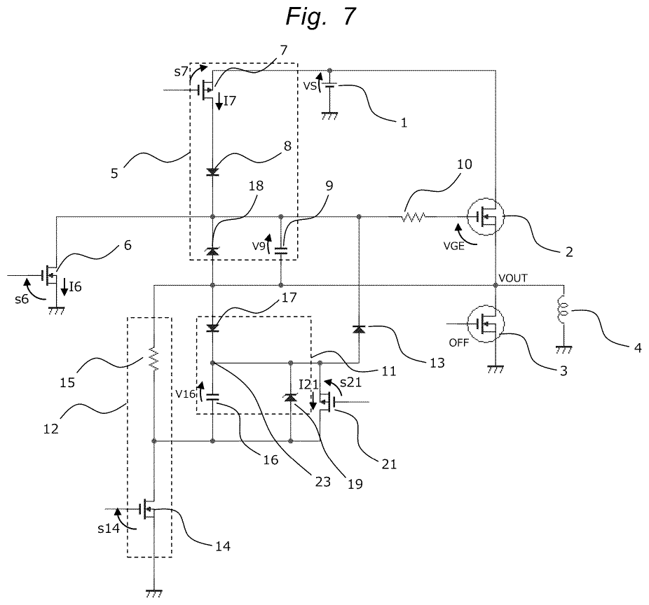

Next, a configuration of an upper arm drive circuit according to a fourth embodiment of the present invention will be described with reference to FIG. 7. A difference from FIG. 5 is that the switching element 21 is provided in parallel to the capacitor 16. In the configuration of the upper arm drive circuit up to the third embodiment, in addition to the charges accumulated in the capacitance between the gate and the source of the switching element 2 at the time of turn-off, the charge accumulated in the capacitor 16 is discharged via the switching element 6. Therefore, at the time of turn-off, the turn-off speed of the switching element 2 decreases as much as the capacitance of the capacitor 16.

According to the configuration of the upper arm drive circuit of the fourth embodiment, the switching element 21 is turned on before the switching element 2 is turned off, and the charges accumulated in the capacitor 16 are discharged, so that the turn-off speed of the switching element 2 can be increased. In addition, when the switching element 14 is turned on while the switching element 2 is turned off, the turn-off speed of the switching element 2 can be accelerated from the middle.

### Fifth Embodiment

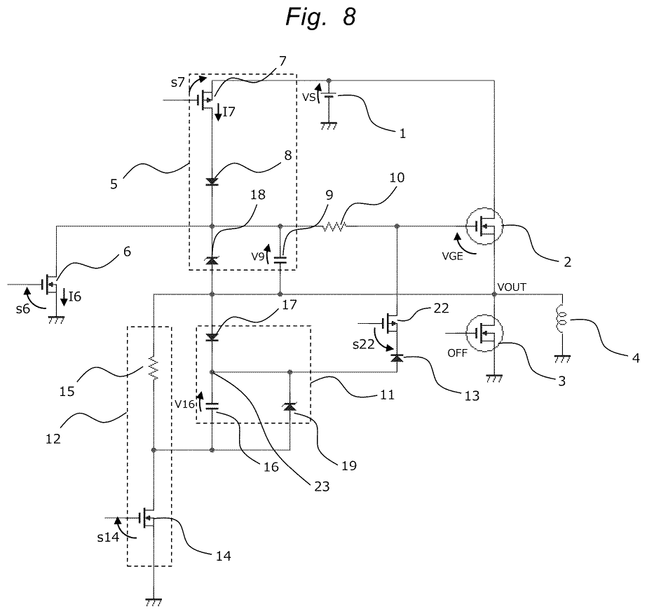

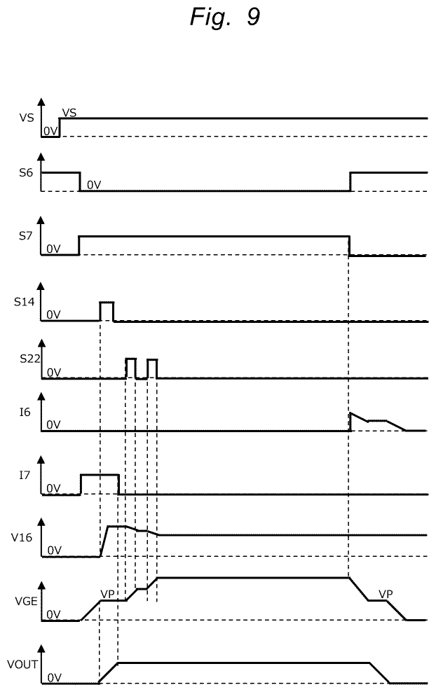

Next, a configuration of an upper arm drive circuit according to a fifth embodiment of the present invention will be described with reference to FIGS. 8 and 9. FIG. 8 is a diagram illustrating a schematic configuration of an upper arm drive circuit of the power conversion device according to the fifth embodiment of the present invention, and FIG. 9 is a timing chart illustrating an operation thereof. The difference from FIG. 5 is that a switching element 22 is provided between the gate of the switching element 2 and the backflow prevention element (diode) 13. In the upper arm drive circuit of the fifth embodiment, the current flowing from the capacitor 16 to the gate of the switching element 2 is controlled by the switching element 22.

By turning on the switching element 22 after the turn-on plateau period, the charges accumulated in the capacitor 16 can be injected into the gate of the switching element 2. At this time, the rising speed of the gate voltage VGE of the switching element 2 can be adjusted by repeating ON and OFF of the switching element 22 in fine time steps.

When the switching element 2 is turned off, if the switching element 22 is turned off, the charges accumulated in the capacitor 16 do not flow into the gate of the switching element 2, so that the turn-off speed of switching element 2 can be improved. Furthermore, for the purpose of reducing noise and surge voltage at the time of turn-off, the turn-off speed of the switching element 2 can be adjusted by temporarily turning on the switching element 22 and injecting the charges accumulated in the capacitor 16 into the gate of the switching element 2.

### REFERENCE SIGNS LIST

1 main power supply
2 upper arm output element (switching element)
3 lower arm output element (switching element)
4 load (coil)
5 turn-on circuit
6 turn-off circuit (switching element)
7 switching element
8 backflow prevention element (diode)
9 capacitor
10 gate delay circuit (resistor)
11 charge storage circuit
12 charge charging/discharging control circuit
13 backflow prevention element (diode)
14 switching element
15 resistance
16 capacitor
17 backflow prevention element (diode)
18 voltage limiting element (Zener diode)
19 voltage limiting element (Zener diode)
20 switching element
21 switching element
22 switching element
23 contact between capacitor 16 and backflow prevention element (diode) 17

1. An upper arm drive circuit that drives and controls an upper arm output element of a power conversion device, the upper arm drive circuit comprising:
a turn-off circuit that is connected between a reference potential of the power conversion device and a gate of the upper arm output element and turns off the gate of the upper arm output element;
a turn-on circuit that is connected between a main power supply of the power conversion device and the gate of the upper arm output element and turns on the gate of the upper arm output element;
a charge storage circuit that includes a first capacitor and a first backflow prevention element;
a charge charging/discharging control circuit including a first switching element and a first resistor; and
a second backflow prevention element, wherein
one terminal of the first capacitor is connected to an output terminal of the power conversion device via the first backflow prevention element, and is connected to the gate of the upper arm output element via the second backflow prevention element, and
another terminal of the first capacitor is connected to a reference potential of the power conversion device via the first switching element, and is connected to an output terminal of the power conversion device via the first resistor.

2. The upper arm drive circuit according to claim 1, wherein the first backflow prevention element prevents a backflow of a current from the one terminal of the first capacitor to the output terminal of the power conversion device, and the second backflow prevention element prevents a backflow of a current from the gate of the upper arm output element to the one terminal of the first capacitor.

3. The upper arm drive circuit according to claim 2, wherein when the turn-on circuit turns on, the first switching element is turned on to accumulate charges from the output terminal of the power conversion device to the one terminal of the first capacitor, and the first switching element is turned off to inject charges from the one terminal of the first capacitor to the gate of the upper arm output element.

4. An upper arm drive circuit that drives and controls an upper arm output element of a power conversion device, the upper arm drive circuit comprising:
a turn-off circuit that is connected between a reference potential of the power conversion device and a gate of the upper arm output element and turns off the gate of the upper arm output element;
a turn-on circuit that is connected between a main power supply of the power conversion device and the gate of the upper arm output element and turns on the gate of the upper arm output element;
a charge storage circuit that includes a first capacitor and a first backflow prevention element;
a charge charging/discharging control circuit including a first switching element and a second switching element; and
a second backflow prevention element, wherein
one terminal of the first capacitor is connected to an output terminal of the power conversion device via the first backflow prevention element, and is connected to the gate of the upper arm output element via the second backflow prevention element, and
another terminal of the first capacitor is connected to a reference potential of the power conversion device via the first switching element, and is connected to an output terminal of the power conversion device via the second switching element.

5. The upper arm drive circuit according to claim 4, wherein the first backflow prevention element prevents a backflow of a current from the one terminal of the first capacitor to the output terminal of the power conversion device, and the second backflow prevention element prevents a backflow of a current from the gate of the upper arm output element to the one terminal of the first capacitor.

6. The upper arm drive circuit according to claim 5, wherein when the turn-on circuit turns on, the first switching element is turned on and the second switching element is turned off to accumulate charges from the output terminal of the power conversion device to the one terminal of the first capacitor, and the first switching element is turned off and the second switching element is turned on to inject charges from the one terminal of the first capacitor to the gate of the upper arm output element.

7. The upper arm drive circuit according to claim 1, wherein when the turn-on circuit turns on, accumulation of charges in the one terminal of the first capacitor and injection of charges into the gate of the upper arm output element are repeated a plurality of times.

8. The upper arm drive circuit according to claim 1, further comprising a first voltage limiting element connected in parallel to the first capacitor.

9. The upper arm drive circuit according to claim 1, further comprising a third switching element connected in parallel to the first capacitor, wherein when the turn-off circuit turns off, charges accumulated in the first capacitor are discharged by turning on the third switching element.

10. The upper arm drive circuit according to claim 1, further comprising a fourth switching element provided between the one terminal of the first capacitor and the gate of the upper arm output element.
